(19) United States
(12) Patent Application Publication
(10) Pub. No.: US 2009/0123617 A1
(43) Pub. Date: May 14, 2009

(54) Syrup concentrate for a frozen carbonated beverage

(76) Inventor: Susan Wood Dunham, Mandeville, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/983,924

(22) Filed: Nov. 13, 2007

(51) Int. Cl. A23L 2/40; A23L 2/52; A23L 2/56; A23L 2/60; A23L 2/68

(52) U.S. Cl. 426/312; 426/548; 426/565; 426/567

(57) ABSTRACT

A syrup for a frozen carbonated beverage has a freezing point suppressant, which can be a sugar or sugar substitute mixed with sucralose. The syrup contains a gelling agent, a foaming agent and an acidic agent that facilitate forming a slushy frozen beverage suitable of being dispensed from a mechanical beverage dispenser having a mixing and chilling chamber after being mixed with carbon dioxide.

### FIELD OF THE INVENTION

The present invention relates to a syrup concentrate that can be used for making a reduced-calorie frozen carbonated beverages and a method of making thereof. More particularly, the present invention relates to reduced-sugar composition that forms syrup suitable for being dispensed in a partially frozen state as part of a frozen carbonated beverage.

### BACKGROUND OF THE INVENTION

Full calorie frozen carbonated beverages (FCBs) are known in the art; they usually contain large quantities of sugar that allows depressing of the freezing point of the slush for dispensing by a special dispensing machines. Such FCB dispensing machines usually include a cylindrical auger chamber, within which a mixing auger or paddle is contained. A refrigeration medium is circulated around the mixing chamber causing the mixture inside the chamber to partially freeze. The mixing auger is rotated to mix the chilled syrup, water and carbon dioxide inside the chamber. When the mixture reaches the desired consistency, the finished product is dispensed from within the mixing chamber by use of a dispensing lever assembly.

The temperature and viscosity of the chilled mixture are carefully controlled to prevent the mixture from reaching a solid frozen state that would inhibit dispensing. It is known that the presence of common sugars, such as sucrose or high fructose corn syrup (HFCS) facilitates depressing of the freezing point, making the mixture more easily dispensable. Conversely, reduction of the amount of sweeteners interferes with the formation of the slush-type frozen beverage that can be dispensed using the conventional frozen beverage machines.

It is also known that salts can be added to liquids for lowering the freezing point of the mixture. However, salt is not a suitable additive to a beverage that is traditionally sweet. Furthermore, the addition of salt can adversely affect the texture of the resultant mixture and make the product unsuitable for consumption.

Some artificial sweeteners, such as aspartame and saccharin can be used as sweeteners in place of common sugars. However, these sweeteners often leave a distinctive aftertaste that also adversely affects the quality of the syrup concentrate and thus the finished product. While it is possible to make an FCB syrup concentrate using low-calorie or non-caloric sweeteners the conventional FCB dispensing machines place serious limitations on the use of such sweeteners because the syrup tends to loose its dispensable characteristics. Should the technology develop a different FCB dispensing machine it is possible to envision a low-calorie or a non-caloric syrup concentrate that can be successfully used as part of a FCB.

One of such attempts is taught in U.S. Application Publication No. 2003/0224095, which discloses the use of erythritol as a freezing point depressant. Erythritol is the sugar alcohol (polyol) that is believed to have a low impact on blood sugar. Erythritol occurs naturally in small amounts in some fruits, and in greater amounts in certain mushrooms and other fungi, and in fermented foods such as wine and soy sauce. The form used in foods is generally made by the fermentation of plant sugars. In the composition of application Pub. No. 2003/0224095, erythritol is used because it is said to be a high-potency non-caloric sweetener. Other listed freezing-point depressing sweeteners are aspartame, saccharin, acesulfame-K, cyclamate, sucralose, isomalt, maltitol, lactitol, or fructo-oligosaccharide sweeteners. The syrup of the application Pub. No. 2003/0224095 does not use a common sugar.

The present invention contemplates elimination of the drawbacks associated with prior full-calorie FCB syrup and provision of a reduced-calorie syrup concentrate for a FCB dispensable through conventional FCB dispensing machines.

### SUMMARY OF THE INVENTION

It is, therefore, an object of the present invention to provide a syrup composition for use with a frozen carbonated beverage.

It is another object of the present invention to provide a reduced sugar, or no-sugar syrup concentrate for use with a frozen carbonated beverage.

It is another object of the present invention to provide a method of making the reduced calorie syrup concentrate for use with a frozen carbonated beverage.

These and other objects of the invention are achieved through a provision of a reduced-calorie syrup concentrate that can be used in frozen carbonated beverages and suitable for dispensing in the form of a slush. The low-calorie syrup can be a reduced sugar composition or a sugar-free composition. The reduced sugar composition uses between about 35 and 35 percent by total weight of sugar, such as HFCS and a high-potency non-caloric sweetener, such as for instance sucralose. The sugar-free low calorie syrup comprises a low molecular weight carbohydrate, for instance polydextrose as a sugar substitute that makes about 34 percent by total weight of the composiiton. Alternatively the low calorie, sugar free composition may contain a starch derivative, for instance maltodextrins mixed with the low molecular weight carbohydrate to make up the approximately one-third by total weight of the composition, as well as the high-potency sugar-free sweetener, such as sucralose.

Both reduced sugar and sugar free syrups of the present invention comprise a preservative, an acidic agent, a gelling agent and a small amount of a foaming agent. The acidic agent is selected from the group comprising malic acid, citric acid and tartaric acid. The gelling agent can be iota carrageenan, and the foaming agent can be natural or artificial substance. In the preferred embodiments, a mixture of Yucca schidigera and Quillaja saponaria extracts is present.

### DETAILED DESCRIPTION OF THE PREFERRED EMBODIMENT

The present invention provides for the use of one or more freezing point depressants, including one or more sweeteners, gelling agent, foaming agent and an acid in sufficient quantities to facilitate depression of the freezing point and forming a reduced-calorie frozen beverage with a slush-like consistency. In a reduced-sugar embodiment, the sweetener can be high fructose corn syrup (HFCS) in combination with sucralose. In a sugar-free embodiment, the present invention provides for the use of a starch derivative, such as low molecular weight carbohydrate. In one of the preferred embodiments, the low molecular weight carbohydrate is a moderately sweet polysaccharide dextrin, in particular maltodextrin, and a soluble fiber synthesized from dextrose. In other sugar-free embodiment, only the soluble fiber sugar substitute can be used.

Maltodextrin can be derived from corn fiber. In one of the preferred embodiments, the soluble fiber substance can be polydextrose, which is synthesized from dextrose, plus about 10 percent sorbitol and 1 percent citric acid. Polydextrose is considered to have significant healthful prebiotic benefits. It contains only 1 kcal per gram and therefore is able to help reduce calories, sugar and starch in the composition of the present invention.

Freezing point depressants for use according to the reduced-sugar embodiment of the present invention include common sugars, such as for instance high fructose corn syrup used in combination with non-caloric high-potency sweeteners. Preferred sugars for use according to the present invention include high fructose corn syrup (HFCS), while the non-caloric high-potency sweetener includes sucralose. In the sugar-free embodiment, the freezing point depressant comprises a sugar substitute, such as for instance polydextrose and maltodextrin.

Both reduced-sugar and sugar-free embodiments use sucralose, a product, wherein three chlorine atoms were selectively substituted for three hydrogen-oxygen groups on the sugar molecule. Additionally, the syrup concentrate composition may contain a food preservative, such as for instance sodium benzoate to impart bacteriostatic properties to the syrup. The syrup composition also comprises an acidic agent, such as dicarboxylic acid, more particularly malic acid. Of course, other acidic agents, such as for instance citric acid and tartaric acid can also be used. The acidic agent imparts a somewhat tart taste to the composition, which balances the sweeteners contained in the syrup. The acid is added in an appropriate amount so as not to interfere with the taste and quality of the resultant beverage.

The syrup of the present invention further comprises a gelling agent, for instance iota carrageenan. The structure of iota carrageenan allows segments of the two molecules to form double helices, which bind the chain molecules in the three dimensional network, thereby imparting thickening properties on the syrup.

In the preferred embodiments, the syrup also comprises a foaming agent that helps carbonization of the beverage. In the preferred embodiments, the foaming agents was a combination of Yucca schidigera and Quillaja saponaria extracts that are considered natural, organic foaming agents, emulsifiers, flavor enhancers and surfactants. They are available from various sources. One of such sources is Desert King International of San Diego, Calif., another—Flavorchem Corporation of San Clemente, Calif.

If desired, the syrup composition may also include a flavor enhancer, such as vanilla and/or almond extract, a coloring agent to impart a desired hue to the syrup, as well a liquid form of vitamin supplement. Such vitamin supplement may contain one or more of the following: Vitamins B3 (niacin), B5 (pantothenic acid), B6 (pyridoxine hydrochloride), B12 (cyanocobalamin), C (ascorbic acid), and D.

The reduced-sugar or sugar-free beverage syrup according to the present invention including a freezing point depressants, has sufficient freezing point depression to provide a dispensable reduced calorie FCB. The product is dispensed in a “slushy” condition, that is the dispensed beverage is not in a solid frozen state and the viscosity of the beverages is higher than its liquid state at room temperature.

The following examples illustrate the characteristics and properties of the invention. However, these examples do not limit the invention. The invention is limited only by the claims appended to this specification.

A reduced sugar (reduced calorie) beverage syrup according to the present invention was produced by combining between about 34.16 and 35.55 percent by weight of HFCS, between about 0.06 and 0.07 percent by weight of sucralose, between about 0.24 and 0.25 percent by weight of an acidic agent, more particularly malic acid, between about 0.79 and 0.81 percent by weight of a gelling agent, more particularly iota carrageenan, and between about 0.31 and 0.32 percent by weight of a foaming agent, such as a mixture of Yucca schidigera and Quillaja saponaria extracts. The reduced sugar syrup may also contain between about 0.10 and 0.11 percent by weight of a preservative, such as sodium benzoate, and between about 6.74 and 7.02 percent by weight of one or more flavoring agents, such as vanilla extract and/or almond extract, all mixed with water to make up 100 percent. This formulation resulted in syrup with the freezing point sufficiently depressed to achieve the production of a slushy-like product inside the frozen carbonated drink dispenser.

A sugar-free beverage syrup according to the present invention was produced by combining between about 34 and 35.55 percent by weight of a sugar substitute, such as polydextrose, or a combination of equal parts of maltodextrin and polydextrose, between about 0.06 and 0.13 percent of a high-potency non-caloric sweetener, such as sucralose, between about 0.24 and 0.25 percent by weight of an acidic agent, more particularly malic acid, between about 0.78 and 0.81 percent by weight of a gelling agent, more particularly iota carrageenan, and between 0.30 to 0.32 percent by weight of a foaming agent, such as a mixture of Yucca schidigera and Quillaja saponaria extracts. The sugar free syrup may also contain between about 0.10 and 0.11 percent by weight of a preservative, more particularly sodium benzoate, and between about 3.40 and 3.42 percent by weight of one or more flavoring agents, such as vanilla extract and/or almond extract, all mixed with water to make up 100 percent. This formulation resulted in syrup with the freezing point sufficiently depressed to achieve the production of a sugar-free slushy-like product inside the frozen carbonated drink dispenser.

If desired, an optional vitamin supplement may be added in the amount of 0.08 percent by weight, while the amount of water is reduced by that percentage. An optional coloring agent may also be added, for instance blue or red food coloring in the amount of about 0.02 percent by weight.

### EXAMPLES

### Example 1

### Reduced-Sugar Syrup Concentrate

A reduced sugar syrup concentrate for a frozen carbonated beverage was prepared by mixing about one-half gallon of water with 30 g of iota carrageenan in a mixer with an overhead blade. The water-gelling agent mixture was vigorously stirred until the gelling agent became rehydrated. With the mixing blade rotating, 4 g of sodium benzoate, 9.2 g of malic acid, 1319.25 g of HFCS, 2.43 g of sucralose, 143.83 g vanilla extract, 116.58 g of almond extract, and a mixture of Yucca schidigera and Quillaja saponaria extracts (in equal amounts totaling 12 g) were added. Then, 0.91 g of red dye and 3 g of vitamin supplements were added; and lastly, the remaining water was mixed with the syrup mixture to form syrup having thick consistency.

The resultant mixture has a freezing point of about 25° F. It was determined that too little of the freezing point depressant causes the syrup to freeze almost immediately in the FCB machine when aerated with carbon dioxide, while too much of the freezing point depressant prolongs the creation of the aerated slushy beverage, which does not freeze until its temperature reaches 32° F.

### Example 2

### Reduced-Sugar Syrup Concentrate

A reduced sugar syrup concentrate for a frozen carbonated beverage was prepared by mixing about one-half gallon of water with 29.4 g of iota carrageenan in a mixer with an overhead blade. The water-gelling agent mixture was vigorously stirred until the gelling agent became rehydrated. With the mixing blade rotating, 3.92 g of sodium benzoate, 9.02 g of malic acid, 1292.87 g of HFCS, 2.38 g of sucralose, 140.95 g vanilla extract, 114.25 g of almond extract, and a mixture of Yucca schidigera and Quillaja saponaria extracts (in equal amounts totaling 11.76 g) were added. Then. 0.89 g of red dye and 2.94 g of vitamin supplements were added; and lastly, the remaining water was mixed with the syrup mixture to form a syrup having thick consistency.

The resultant composition has a freezing point of about 25° F. when aerated with carbon dioxide.

### Example 3

### Reduced-Sugar Syrup Concentrate

A reduced sugar syrup concentrate for a frozen carbonated beverage was prepared by mixing about one-half gallon of water with 30.60 g of iota carrageenan in a mixer with an overhead blade. The water-gelling agent mixture was vigorously stirred until the gelling agent became rehydrated. With the mixing blade rotating, 4.08 g of sodium benzoate, 9.38 g of malic acid, 1345.64 g of HFCS, 2.48 g of sucralose, 146.71 g vanilla extract, 118.91 g of almond extract, and a mixture of Yucca schidigera and Quillaja saponaria extracts (in equal amounts totaling 12.24 g) were added. Then, 0.93 g of red dye and 3.06 g of vitamin supplements were added; and lastly, the remaining water was mixed with the syrup mixture to form a syrup having thick consistency.

Similarly to Examples 1 and 2 above, the composition of Example 3 has a freezing point of about 25° F. when aerated with carbon dioxide.

### Example 4

### Sugar Free Syrup Concentrate

A sugar-free syrup concentrate for a frozen carbonated beverage was prepared by mixing about one-half gallon of water with 30.28 g of iota carrageenan in a mixer with an overhead blade. The water-gelling agent mixture was vigorously stirred until the gelling agent became rehydrated. With the mixing blade rotating, 4.0 g of sodium benzoate, 9.20 g of malic acid, 651.39 g of maltodextrin, 651.39 g of polydextrose, 4.86 g of sucralose, 28.25 g of vanilla extract, 101.07 g of almond extract, 2.27 g of Yucca schidigera extract, and 9.08 g of Quillaja saponaria extract were added. Then, 0.453600 g of red dye and 0.0024 g of blue dye were added; and lastly, the remaining water was mixed with the syrup mixture to form syrup having thick consistency.

Similarly to Examples 1-3 above, the composition of Example 4 has a freezing point of about 25° F. when aerated with carbon dioxide. The corn fiber of this example is a higher molecular number maltodextrin; it has 4 calories per gram as sucrose or dextrose. The polydextrose is a cross-linked glucose polymer of glucose and citrate. The polydextrose has about 1 calorie per gram with a molecular weight of about 2500 Daltons. It is water soluble.

### Example 5

### Sugar-Free Syrup Concentrate

A sugar-free syrup concentrate for a frozen carbonated beverage was prepared by mixing about one-half gallon of water with 30.28 g of iota carrageenan in a mixer with an overhead blade. The water-gelling agent mixture was vigorously stirred until the gelling agent became rehydrated. With the mixing blade rotating, 4.0 g of sodium benzoate, 9.20 g of malic acid, 1302.77 g of polydextrose, 4.86 g of sucralose, 28.25 g of vanilla extract, 101.07 g of almond extract, 2.27 g of Yucca schidigera extract, and 9.08 g of Quillaja saponaria extract were added. Then, 0.453600 g of red dye and 0.0024 g of blue dye were added; and lastly, the remaining water was mixed with the syrup mixture to form syrup having thick consistency.

Similarly to Examples 1-4 above, the composition of Example 5 has a freezing point of about 25° F. when aerated with carbon dioxide. The sugar substitute in this example is polydextrose, which is a cross-linked glucose polymer of glucose and citrate. The soluble polydextrose has about 1 calorie per gram with a molecular weight of about 2500 Daltons.

The consistency of examples 4 and 5 was that of a smooth, creamy frozen pudding somewhat different from the slushy mouth feel of Examples 1 through 3. When using different frozen beverage machines, artisans in the field ca make adjustments to the composition of Examples 1 through 5 and cause depressing of the beverage freezing point to the desired level.

A reduced sugar frozen carbonated beverage was prepared from the syrup using examples 1 through 5, which was deposited into a frozen carbonated beverage machine and agitated in the chilling chamber, while carbon dioxide was sprayed in. The mixture was “fluffed” to form a slushy product and dispensed from the machine in a conventional manner. The sweetener system had depressed freezing point about 25° F.

Many changes and modifications can be made in the examples of the present invention without departing from the spirit thereof. I therefore, pray that my rights to the present invention be limited only by the scope of the appended claims.

I claim:

1. A reduced-calorie syrup concentrate for frozen carbonated beverage, comprising:
a freezing point depressant, a sweetener, an acidic agent, a gelling agent, and a foaming agent mixed with water and chilled to form a slushy.

2. The composition of claim 1, wherein said freezing point depressant is a sugar or sugar substitute.

3. The composition of claim 2, wherein said sugar is high fructose corn syrup.

4. The composition of claim 2, wherein said sugar substitute is chosen from at least one soluble fiber sugar substitute and a starch derivative.

5. The composition of claim 4, wherein said at least one soluble fiber sugar substitute is polydextrose and said at least one starch derivative is maltodextrin.

6. The composition of claim 1, further comprising a food preservative.

7. The composition of claim 1, wherein said acidic agent is chosen from at least one malic acid, citric acid and tartaric acid.

8. The composition of claim 1, wherein said gelling agent is chosen from at least one Yucca schidigera extract and Quillaja saponaria extract.

9. The composition of claim 8, wherein said sweetener is a high-potency sugar-free sweetener.

10. The composition of claim 10, wherein said sweetener is sucralose.

11. A syrup composition, comprising: between about 34.16 and 35.55 percent by weight of sugar or sugar substitute, between about 0.06 and 0.07 percent by weight of high-potency sweetener, between about 0.24 and 0.25 percent by weight of an acidic agent, between about 0.78 and 0.81 percent by weight of a gelling agent, and between about 0.30 and 0.32 percent by weight of a foaming agent mixed with water.

12. The composition of claim 11, further comprising between about 6.88 and 7.02 percent by weight of one or more flavoring agents.

13. The composition of claim 11, further comprising between about 3.4 and 3.42 percent by weight of one or more flavoring agents.

14. The composition of claim 11, further comprising between about 0.10 and 0.11 percent by weight of a food preservative.

15. The composition of claim 11, wherein said sugar is high fructose corn syrup.

16. The composition of claim 11, wherein said sugar substitute is chose from at least one of polydextrose and maltodextrin.

17. The composition of claim 11, wherein the high-potency sweetener is sucralose, said acidic agent is chose from one at least one of malic acid, tartaric acid and citric acid, and said foaming agent is chosen from at least one of Yucca schidigera extract and Quillaja saponaria extract.

18. A method of making a reduced calorie syrup for frozen carbonated beverage suitable for dispensing from a mechanical beverage dispenser having a mixing and chilling chamber, comprising:
(a) mixing in a mixing vessel, a gelling agent with a pre-determined amount of water, adding to the mixing vessel a pre-determined amount of each freezing point depressant, a gelling agent, an acidic agent and a foaming agent to form a syrup;
(b) depositing the syrup into the mixing and chilling chamber and spraying the syrup with carbon dioxide, while reducing temperature inside the mixing and chilling chamber to a sufficient degree to form a frozen carbonated beverage of slushy consistency.

19. The method of claim 18, wherein said freezing point depressant comprises sugar or sugar substitute.

20. The method of claim 19, wherein said sugar is a sweetener comprising high fructose corn syrup and sucralose.

21. The method of claim 19, wherein said sugar substitute is a sweetener comprising chosen from at least one of polydextrose and maltodextrin, mixed with sucralose.

22. The method of claim 18, further comprising a step of adding a flavoring agent chosen from at least one of vanilla extract and almond extract.

23. The method of claim 18, wherein said gelling agent is iota carrageenan, said foaming agent is chosen from at least one of Yucca schidigera extract Quillaja saponaria extract.
